(19) United States
(12) Patent Application Publication
(10) Pub. No.: US 2004/0243699 A1
(43) Pub. Date: Dec. 2, 2004

(54) Policy based management of storage resources

(76) Inventors: Mike Koclanes, Boulder, CO (US); Craig Reed, Louisville, CO (US); Mark Feilinger, Loveland, CO (US); Aloke Guha, Louisville, CO (US)

Correspondence Address: FENWICK & WEST LLP, SILICON VALLEY CENTER, 801 CALIFORNIA STREET, MOUNTAIN VIEW, CA, 94041, US

(21) Appl. No.: 10/447,677

(22) Filed: May 29, 2003

(51) Int. Cl. G06F 15/173

(52) U.S. Cl. 709/224; 709/225

(57) ABSTRACT

Policy based management of storage resources in a storage network. Service level objectives are associated with storage resource requestors such as applications. A set of policy rules is established in connection with these service level objectives. An update of the configuration of the storage network, such as a provisioning of storage resources for the application, is performed according to a workflow that implements the policy rules, which allows the service level objectives of the application to be automatically satisfied by the new provisioning. Metrics are used to ensure that service level objectives continue to be met.

### BACKGROUND OF THE INVENTION

1. Field of the Invention

This invention relates generally to policy based network storage management, and more particularly to automatic provisioning and management of shared storage resources in a storage network

2. Description of the Related Art

The growth in electronic information has led to emergence in new network storage technologies, such as storage area networks (SANs), network attached storage (NAS), and storage management software. While these have largely addressed the requirements of scalability, availability, and performance, they have also increased the complexity of managing storage and actually increase the total cost of ownership (TCO).

In the past the choices for provisioning storage for a given application where limited to directly attached bus storage. Storage networking technologies have resulted in a more complex set of choices of storage resources that need to be considered when provisioning. A solution could be directly attached or within the local IP Network, or the storage area network (SAN), or even across the metropolitan area network (MAN), or wide area network (WAN).

Various storage requirements underlie the storage management problem, including (1) increased scalability, (2) increased availability and accessibility, (3) increased demands on performance, and (4) reduced management complexity and total cost of ownership.

Regarding scalability, fast, reliable access to an ever-growing supply of data has become a top priority for enterprise and service provider IT managers. The growth of data continues unabated even with the perceived slowdown in technology spending.

On the availability and accessibility side, companies have been increasing the amount of data collected to analyze and improve their business from internal sources as well as from suppliers, and current and potential customers. The value of this data has created a growing dependence on constant availability, anytime and from anywhere in the world. These applications are dependent on timely access to content, requiring needs of accessibility, availability, and data protection. Lack of availability of corporate information can have a profound impact on productivity.

Performance demands have also been increasing. Expanding business applications, from CRM (customer relationship management) and ERP (enterprise resource planning) to email and messaging, are placing a strain on storage systems in terms of response time as well as I/O performance. Each application has different characteristics and priorities in terms of access and I/O performance, besides availability, back up, recovery and archiving needs. This results in management complexity. In a shared storage environment, IT administrators must now consider the different performance factors of every application when analyzing and provisioning storage.

Even with all of these demands, there is a corresponding push for reduced management complexity and total cost of ownership. Storage is an increasing portion of information systems budgets. Several factors contribute to the rising costs of storage management. One is that the number of trained IT professionals to manage storage is scarce due to the complexity of storage operations. Reliance on manual operators also results in human errors in managing storage and system outages, resulting in significant impact on productivity. In addition, with the explosive growth of data under management, enterprises are faced with significant data center architectural issues. Traditional storage architectures have become decentralized and have led to physically scattered storage assets throughout the enterprise and poorly utilized hardware. IT managers are frustrated because the dispersed network storage products are constantly running out of storage capacity or throughput. This results in unplanned downtime of applications as IT administrators must implement incremental storage devices and network extensions to meet the growth needs.

Existing solutions to the storage management problem have been inadequate. New technology strategies have emerged over the last several years aimed at helping enterprise and service providers cope with the needs of growing storage. Unfortunately, due to trends driving the storage requirements previously mentioned, each of these solutions has only solved a subset of the problems facing data center managers. These technologies leverage the concept of shared storage, defined as common storage that can be accessed by many servers or applications through a network.

One such solution is the Storage Area Network (SAN). SANs are targeted at providing scalability and performance to storage infrastructures. SANs establish a separate network for the connection of servers to I/O devices (tape drives and disk drive arrays) and the transfer of block level data between servers and these devices. The advantages of SANs are scalability of storage capacity and I/O without depending on the LAN, thereby improving application performance.

Network Attached Storage (NAS) is targeted at increasing accessibility of data, and reducing implementation costs. A NAS device sits on the LAN and is managed as a network device that serves files. Unlike SANs, NAS has no special networking requirements, which greatly reduces the complexity of implementing it. NAS′ shortcoming is its inability to scale or provide the performance headroom possible in a SAN environment. NAS is easy to implement but difficult to maintain when multiple devices are deployed, increasing management complexity.

Technical advances in the physical storage subsystems, whether direct attached storage (DAS), NAS, or SAN-attached, together with mirroring and replication technologies, have largely addressed the issues of reliability of physical devices, not the larger storage infrastructure.

While some conventional storage technologies have met some storage requirements, such solutions remain inadequate in terms of lowering total cost of ownership, assuring application availability, and providing manageability in an increasingly complex storage environment.

### SUMMARY OF THE INVENTION

The present invention provides policy-based management of storage resources.

In one aspect, policy based management of storage resources in a storage network is accommodated by associating service level objectives with storage resource requesters such as applications. A set of policy rules is established in connection with these service level objectives. An update of the configuration of the storage network, such as a provisioning of storage resources for the application, is performed according to a workflow that implements the policy rules, which allows the service level objectives of the application to be automatically satisfied by the new provisioning.

In another aspect, the policy rules include threshold policies. A metric corresponding to the threshold policy is derived, and aspects of the storage network are monitored against the metric. When an out of bounds condition is detected the storage network is automatically reconfigured, again using the policy rules, so that the service level objectives of the application continue to be satisfied even where changes to the storage network that would ordinarily result in a failure to meet those objectives occur.

In another aspect, in updating a configuration of the storage network such as a new provisioning, it is determined that multiple potential storage resource configurations will satisfy the service level objectives of the storage resource requestor using the set of policy rules. In response to this determination, an optimization algorithm is used to select from among the options. Preferably, the optimization algorithm prompts selection based upon a maximized likelihood that the service level objectives of the storage resource requestor will be met by the selected configuration.

In another aspect, the set of service level objectives corresponding to the application are determined from a class of service having predetermined service level objectives. The class of service may be wholly adopted or supplemented by service level objectives particular to the application. Additionally, the various different applications using storage resources in the storage network may and will likely have different service level objectives. Thus, for example, a provisioning related to a second application invokes its service level objectives and corresponding policy rules.

In still another aspect, the workflow for an update (e.g., a provisioning of new storage for an application) includes a plurality of workflow steps that implement the policy rules. These steps can include analysis steps that make initial determinations regarding a storage allocation according to a scenario prescribed by the set of policy rules, and action steps that carry out the storage allocation. According to this aspect, an audit trail is retained as the plurality of workflow steps are performed. Additionally, a user confirmation can be sought and received, such as prior to completing the action steps. The audit trail allows returning to a state prior to that for a completed workflow step. For example, a user may decline to go forward with the action steps, and return to a prior state. The user may subsequently complete the provisioning according to more desired scenarios.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a schematic diagram illustrating an example of a storage area network (SAN) 100 that includes a policy based storage management server;

FIG. 2 is a flow diagram illustrating an embodiment of a process for policy-based monitoring and controlling of storage resources in accordance with the present invention;

FIG. 3 is a flow diagram illustrating an embodiment of deriving policy rules from service level objectives in accordance with the present invention;

FIG. 4 is a flow diagram illustrating the determination of control actions in connection with a provisioning sequence for allocating storage;

FIG. 5 is a schematic diagram illustrating an example of optimization in accordance with the present invention;

FIG. 6 is a flow diagram illustrating an example of a workflow for allocating a virtual disk and assigning it to a server in accordance with the present invention; and

FIG. 7 is a block diagram illustrating an embodiment of a policy based storage resource management system.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

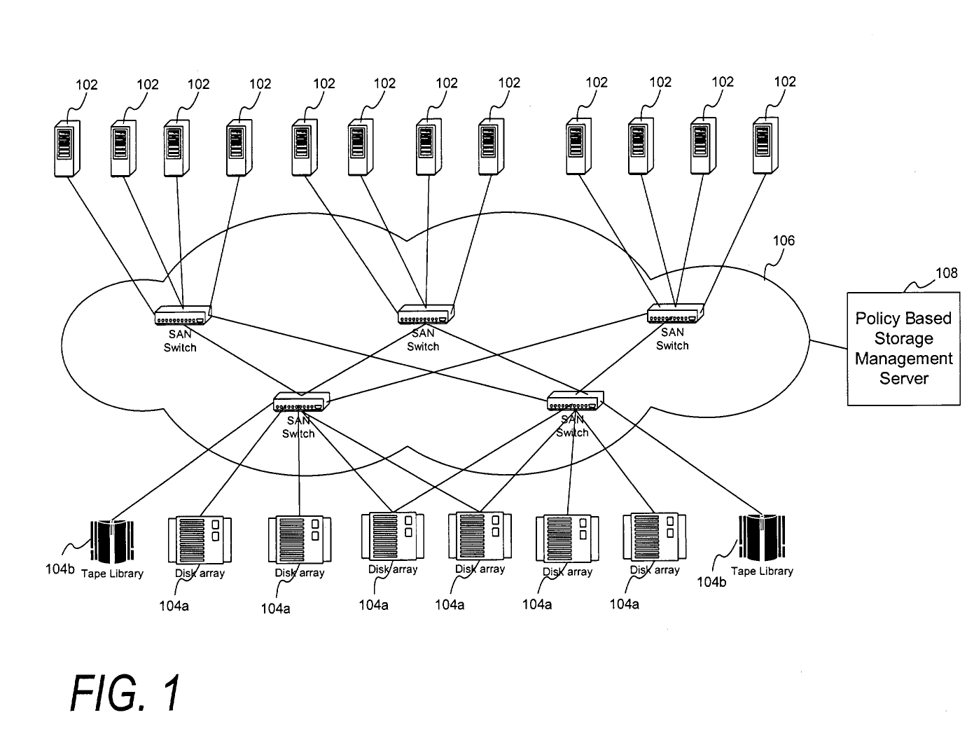

FIG. 1 is a schematic diagram illustrating an example of a storage area network (SAN) 100 that includes a policy based storage management server 108.

Application servers 102 are connected to storage resources including disk arrays 104a and tape library storage 104b through a storage area network (SAN) fabric 106. Although not shown, host bus adapters (HBAs) are also typically provided. The SAN fabric 106 is usually comprised of Fibre Channel (FC) switches. The interconnection of the application servers 102, SAN fabric 106 and storage resources 104a,b is conventional. The SAN is generally a high-speed network that interconnects different kinds of data storage devices with associated servers. This access may be on behalf of a larger network of users. For example, a SAN may be part of an overall network for an enterprise. The SAN may reside in relatively close proximity to other computing resources but may also extend to remote locations, such as through wide area network carrier technologies such as asynchronous transfer mode or Synchronous Optical Networks, or any desired technology, depending upon requirements.

Conventional SANs variously support disk mirroring, backup and restore, archival and retrieval of archived data, data migration from one storage device to another, and the sharing of data among different servers in a network. SANs may also incorporate sub-networks with network-attached storage (NAS) systems, as discussed above.

Although this example is shown, it should be understood that distributed storage does not necessarily have to be attached to a FC SAN, and the present invention is not so limited. For example, policy-based storage management may also apply to storage systems directly attached to a LAN, those that use connections other than FC such as IBM Enterprise Systems Connection, or any other connected storage. These various systems are generally referred to as storage networks.

In contrast to conventional systems, the policy based storage management (PBSM) server 108 is also incorporated into the SAN 100. The PBSM server 108 is configured to communicate with the application servers 102 and the storage resources 104a,b through the SAN fabric 106. Alternatively, the PBSM server 108 performs these communications through a separate control versus data network over IP (or both the separate network and the SAN fabric 106), providing out of band management. The PBSM server 108 determines and maintains service level objectives for various applications using storage through the SAN 100, determines corresponding policies, implements metrics to ensure that policies and services level objectives are being adhered to, and provides workflows for provisioning storage resources in accordance with the policies.

In one aspect, policy-based management of storage resources incorporates automatically meeting a set of service level objectives (SLOs) driven by policy rules. Optionally, these SLOs may correspond to a service level agreement (SLA). Some of the policy rules are technology driven, such as those that pertain to how a particular device is managed. Others may be more business oriented. For example, a business policy may mandate that a particular application is a mission critical application. Rules corresponding to that business policy could include a requirement for redundancy and synchronous recovery for any storage resources used by the mission critical application.

The various policy rules are maintained in a policy rules database. Generally, a given type of device will correspond to a default set of defined policy rules. The definition of these policy rules will typically be user driven. For example, a policy for an application may correspond to an SLO of high recoverability. The policies for this SLO could be recovery within ½ hour, cache optimized arrays, mirrored raid, etc. A provisioning for that application is conducted according to those rules. Additionally, even after provisioning, metrics are used to proactively measure against SLOs. If there is a failure to meet such a metric, another provisioning is prompted to correct the failure. For example, where there is a failure related to a performance metric (and policy), provisioning can re-route through a different fabric to adopt a less used route that is better able to meet the performance requirements. In addition to new provisioning, policies can be reviewed to determine whether they remain adequate in light of the SLOs.

Storage requests can be variously received, such as from an application or administrator. Policy-based management ensures that all actions taken on the shared resources are compliant with the specified business policies.

The SLOs for applications will vary. Every enterprise operates on its core operational competency. For example, CRM is most critical to a service provider, and production efficiency is most critical to a manufacturing company. The company's business dictates the relative importance of its data and applications, resulting in business policies that must apply to all operations, especially the infrastructure surrounding the information it generates, stores, consumes, and shares. In that regard, SLOs for metrics such as availability, latency, and security for shared storage are guaranteed in compliance with business policy.

According to this aspect of the present invention, policy-based management of storage resources is met by automatically configuring the system in various respects. As the data center environment evolves, due to changes in data request load or availability, storage devices are automatically reconfigured to meet capacity, bandwidth, and connectivity demands. Also, any storage management scenario that changes the configuration of storage resources invokes a provisioning process. This provisioning process is carried out by workflow having a set of steps that are automatically performed to carry out the provisioning. This accommodates rapid responses to changes, and meeting SLOs. Finally, the definition of quality of service incorporates various policies and includes the application or line of business level.

One feature of the present invention is optimization of the storage infrastructure while retaining the policy-based management of the corresponding storage resources. An optimization of the storage infrastructure on the set of SLOs specified for data protection, availability, performance, security and fail over. Based on the status of the storage environment, actions to meet the SLOs are analyzed and recommended.

Growing storage dynamically as required for the application is often referred to as “dynamic expansion.” This is a significant consideration since inability to expand can be a cause of downtime. Another feature of this aspect is automatic monitoring of storage devices and the corrective action process to proactively prevent downtime. Furthermore, the expansion of capacity must consider SLOs for other applications.

Cost reduction through higher resource utilization is also more easily accommodated in accordance with the present invention. Installed storage is often underutilized because IT managers are concerned about compromising service levels that are easier to manage in dedicated storage or SAN islands. However, the potential savings of shared SANs are significant. The PBSM 108 allows the SAN to be implemented by preference, while not compromising service levels in the shared environment.

Closed-loop control and automation is also accommodated. This provides the customer with the ability to seamlessly provision discrete storage elements, from storage applications, to switches, to storage systems, as one entity. Closed-loop control of the storage resources provides proactive responses to changes in the environment, which results in reducing downtime costs and meeting service levels. The ability to include vendor-specific device characteristics allows control of heterogeneous storage resources independent of vendor type or device type.

The integrated approach of the present invention, which delivers storage on demand, without necessitating involvement of servers or users in consideration of data location, multiple storage suppliers, or the details of storage administration, controls storage management costs as application requirements grow by reducing the complexity and labor-intensive nature of storage management processes.

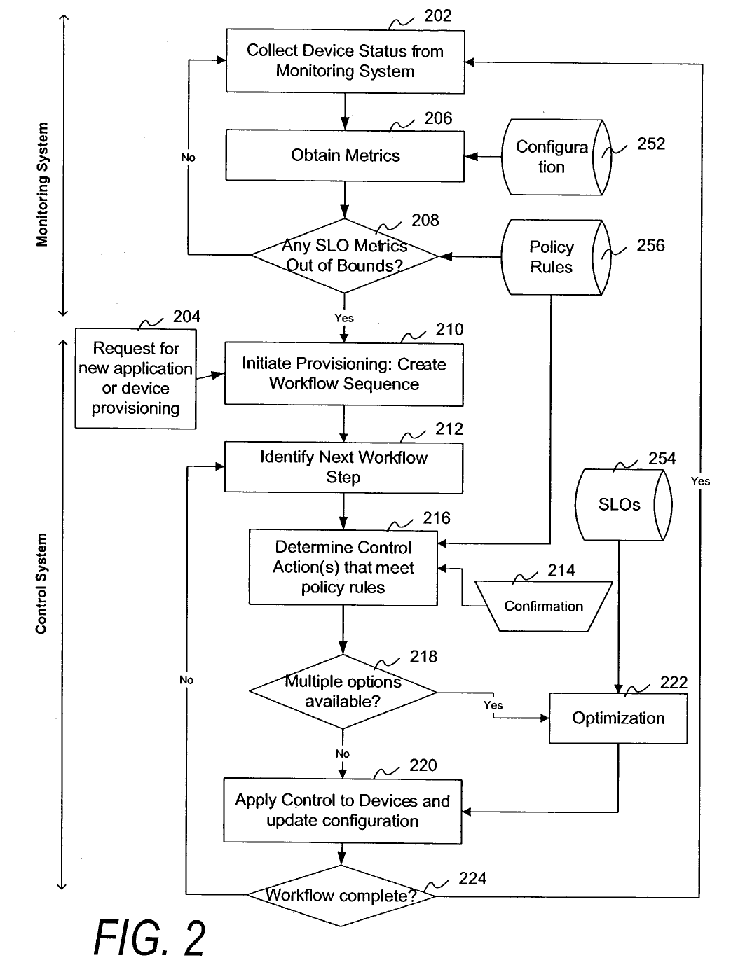

FIG. 2 is a flow diagram illustrating an embodiment of a process 200 for policy-based monitoring and controlling of storage resources in accordance with the present invention. As indicated, the process 200 includes components corresponding to a monitoring system and a control system. Although the process 200 could be variously implemented, in one embodiment it is carried out by a PBSM server employing monitoring and control systems.

To observe the current state of storage resources, a monitoring system continuously collects 202 data on the status of all storage resources and applications that consume storage. Examples of storage resources include storage devices, disk arrays, tape libraries, HBAs, storage gateways, and others. The status data preferably includes health and performance data. Health data generally refers to whether the device under observation is operating correctly, and is used to determine whether the storage resource is and remains a viable candidate for providing storage according to requirements described herein. Performance data includes bandwidth, response time, transactions per second, I/O operations per second, and other metrics. The status data can be collected using conventional technologies including but not limited to those that implement the Common Information Model (CIM) based Storage Management Initiative (SMI) established for management interoperability across multi-vendor storage networks by the Storage Network Industry Association; SNMP Mibs; and proprietary APIs for storage resources of various vendors.

A request 204 such as for device provisioning initiates changes in the storage system. This can be fully automated or through manual intervention by a data center operator. The data center configuration information is kept in a configuration database 252.

The information in the configuration database 252 is consulted in obtaining 206 system metrics. Metrics are directly collected from device status information (e.g., frame buffer counts), or derived. The monitored data is processed to obtain metrics that are measures of performance against the service level objectives of the storage management system. For example, to measure the storage I/O rate for an application on a server, the round trip delay experienced by the application at the storage interface is measured. If this measurement is not directly available, then it is estimated from the round trip time from individually measured latencies at HBA, switch and storage system level.

To ensure that SLOs are being met, the metrics are compared 208 to reference information that corresponds to the SLOs. In one embodiment, this is accommodated by comparing the metrics to policy rules that include threshold policies. The term threshold policies refers to any set of conditions against which a metric can be compared to detect out of bounds operation, and does not necessarily require comparison to a fixed threshold. Examples of the conditions include high or low thresholds, or those defined by control limits and statistical sampling. As indicated, the policy rules are accessible from a policy rules database 256, described further below.

If no metric is out of bounds, monitoring continues as indicated. However if any metric is determined to be out of bounds, a provisioning change is initiated 210. An example of out of bounds determination is where an application server reaches a threshold in capacity thereby violating an allocated storage capacity SLO (and corresponding policy rule). There, a provisioning action to allocate additional storage capacity is initiated.

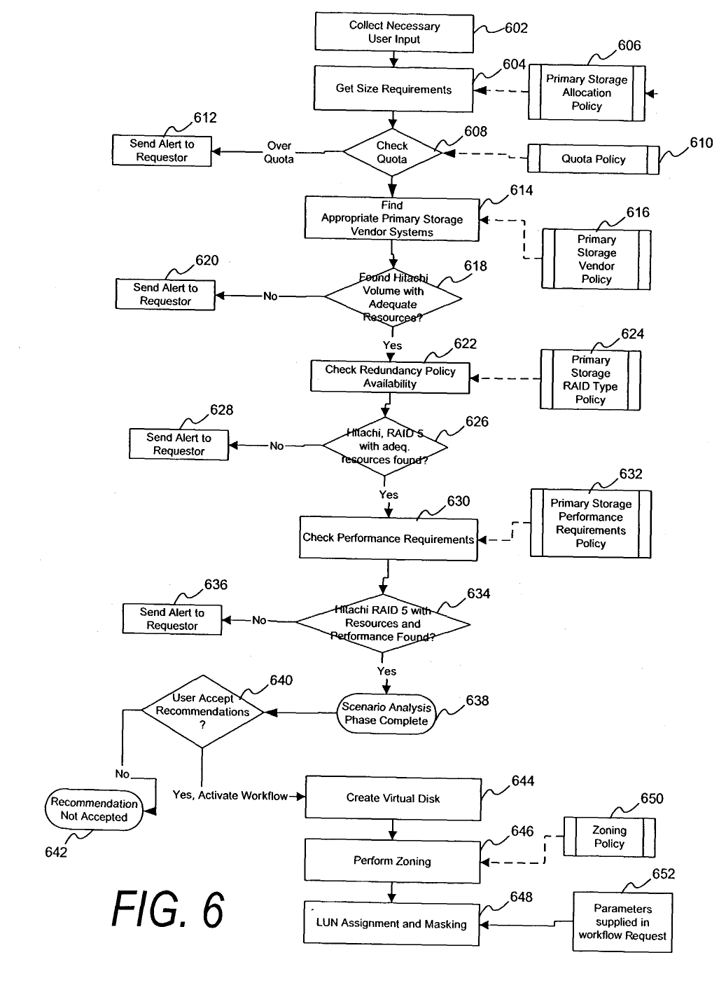

The workflow for a provisioning action includes a sequence of steps. A workflow template pre-exists for a particular type of provisioning activity. For example, the creation of a volume for a new files system or new databases for a server or servers. Another example is the expansion of a volume for an existing file system or database. Other types of workflows are to provision multiple volumes for a given application and/or servers or to add a new server to a cluster and to clone the volume mapping and network paths and of the existing servers in the cluster. Two examples of launching the appropriate workflow template follow. First, there may be a user initiated service request to perform one of the provisioning activities as described above. The user selects the workflow by entering a service request through a GUI. For provisioning requests for new storage, the user supplies the relevant information, the host, the amount of storage required and the application class of service requested, as well as Service Level Objectives such as maximum time and cost to provision. Secondly, a workflow may be triggered by an event or threshold being reached. For example, a threshold policy that states that when a given file system reaches a certain percentage utilization to trigger the launch of the expand volume for a file system workflow. A detailed example for a workflow is described below in connection with FIG. 6.

Still referring to FIG. 2, each step in a workflow usually involves executing an action related to setting or modifying the configuration of some storage resource. Provisioning continues by identifying 212 the next workflow step in the sequence, which of course is the first workflow step if the sequence is just commencing. The workflow step being executed may be referred to as the current workflow step.

Processing the current workflow step entails an initial determination 216 of the set of control actions required to meet applicable policy rules.

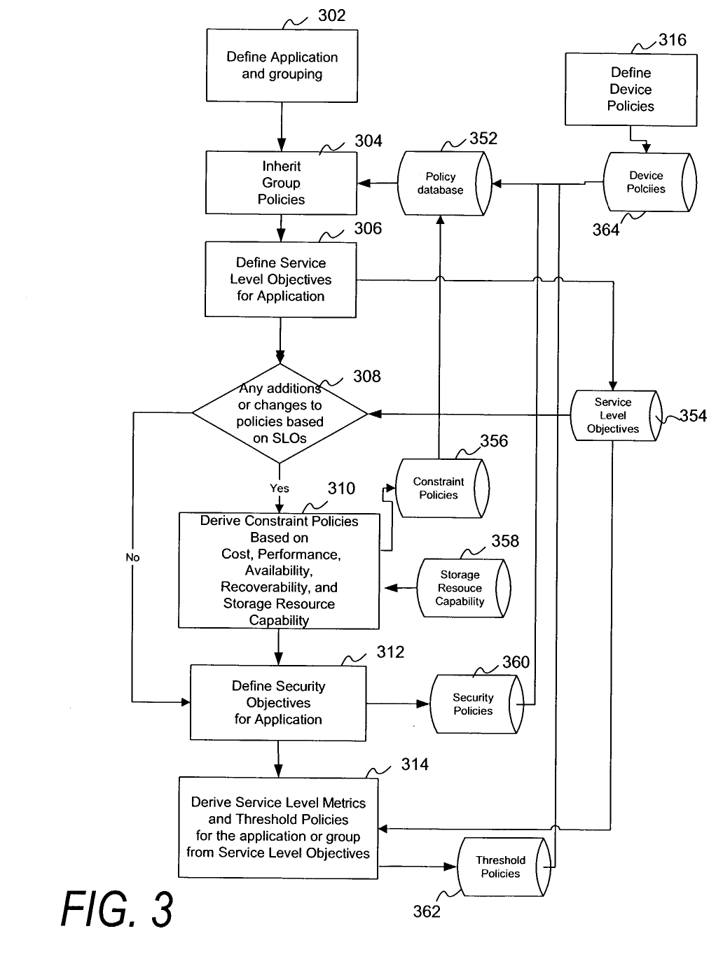

The policy rules are maintained in a policy rules database 256. In addition to the previously mentioned threshold policies, policy rules include security policies and constraint policies. Also, policy rules may be conceptually categorized as pertaining to applications or devices. Applications may also belong to a class of applications with corresponding SLOs, policy rules and/or metrics. For example, for a given class of applications, a constraint policy might be that any application in the class must be provisioned with a mirrored set of storage, with synchronous replication to another mirrored set. This is a constraint policy that happens to be application driven. An example of a device constraint policy is to require assignment of ports on a particular vendor's (e.g., EMC) arrays by looking at average bandwidth and picking the lowest utilized bandwidth. This is also a constraint, but it is a device driven constraint. The process for deriving policy rules from service level objectives is described below with reference to FIG. 3.

Some workflow steps require input 214. Constraint policy rules are among the policy rules that may need to be considered for each step of a workflow. The policy rules in turn are used to determine the control action. Constraint policy rules may have been derived from the SLOs for the application or line of business, and are a good example of the type of rules that may require input. For example, input may be sought from an information systems administrator, a database administrator, a storage administrator, or others. Therefore the workflow must be able to distribute the steps to the appropriate role and responsibility. This aspect of the workflow is derived from a set of security policies, which are a subset of the policy rules. Once identified according to the workflow, such input can be sought and obtained using conventional techniques such as communications using the computer network or the like.

Actions can also be constrained by policies that define desired methods for configuring vendor specific storage resources or combinations of vendor's storage resources. For example, some storage arrays have array to array mirroring capabilities or different levels of control for port assignment. An example of a device specific policy is to define the rules by which a volume in an array is mapped to a port. This may be by a round robin method, or lowest peak utilization, or lowest average utilization. Again these policies determine how the configuration action will be executed.

Once the control actions are determined 216, it is next determined 218 whether multiple options are available for the workflow step. If not, then the control actions are immediately applied 220 to the corresponding devices. However, if there are multiple options, then optimization is applied 222.

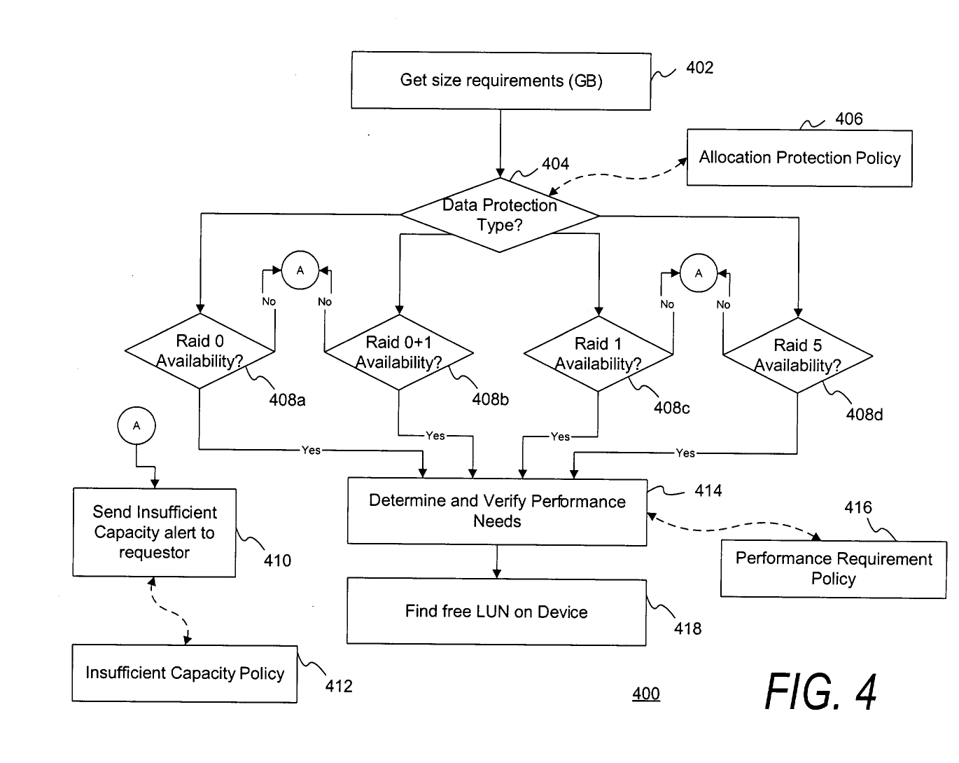

Referring to FIG. 4 along with FIG. 2, an example of determining control actions 400 is described in more detail. Particularly, in connection with a provisioning sequence for allocating storage, various decision points and corresponding policy rules are illustrated. More specifically, control actions corresponding to obtaining 402 size requirements corresponding to the provisioning sequence are shown. Policies may be variously named in connection with their specific applicability to provisioning, but can still be categorized as previously described. For example, the “Allocation Protection” policy is an example of a constraint policy that describes what must be done in terms of the provisioning of a particular RAID type. Additionally, if security or threshold aspects are involved, then the policy may also be those types of policies. An initial determination 404 is made as to the data protection type that will be provided under the provisioning sequence, which entails an examination 406 of the allocation protection policy for the application corresponding to the sequence. Although the options may vary, here the data protection type options are indicated as RAID 0, RAID 0+1, RAID 1, and RAID 5, which are all conventional definitions for redundant storage. For example, RAID 0 is a technique that implements striping but no data redundancy; RAID 1 is sometimes referred to as disk mirroring, and does involve the duplicate storage of data, typically; and RAID 5 corresponds to a rotating parity array. RAID 0+1 (also referred to as RAID 0 1) is striping (RAID 0) and mirroring (RAID 1) combined, without parity (redundancy data) having to be calculated and written. The advantage of RAID 0 1 is fast data access (like RAID 0), but with the ability to loose one drive and have a complete duplicate surviving drive or set of drives (like RAID 1). RAID 0 1 still has a disadvantage of losing half of allocated drive space for redundancy. Again, the type of RAID required corresponds to the allocation protection policy. Once that is understood, the availability for the appropriate service is requested. Thus, if RAID 0 is required, then the availability of such is checked 408a, whereas if the other described RAID storage options are required, the availability of such storage, in the amount specified by the size requirements, is respectively checked 408b-d. In any case, if it is determined 408a-d that there is insufficient capacity for the determined data protection type at the specified size, then insufficient capacity actions are invoked, such as sending 410 an alert to the requestor (e.g., application) corresponding to the provisioning sequence. Additionally, policy rules are examined 412 for insufficient capacity scenarios. The “Insufficient Capacity” is a policy rule that describes what action to take if the there isn't enough available RAID capacity of the type required to meet the provisioning request. For example, the rule might be to add incremental capacity into the RAID pool if raw extent capacity exists in the array and then to continue the normal volume creation workflow. Furthermore, if there isn't any available raw extent capacity, it may identify whether to send an alerting email and to whom or perhaps to send an SNMP trap to the enterprise management tool used in the enterprises NOC (network operation center).

If the availability of the appropriate type of storage is confirmed, then the performance needs are determined and verified 414 in a similar fashion. Again, policy rules are examined 416 to determine the performance needs, here referred to as performance requirement policies. Once the needs are determined, availability is checked. If sufficient performance is not found, then insufficient performance actions and corresponding policies can be implemented, as described in connection with a determination of insufficient capacity. On the other hand, if availability of the required data protection type according to the required performance is found, allocation proceeds by finding 418 free LUN on the device corresponding to the required allocation protection and performance requirement policies. Although policies and corresponding actions are described in connection with allocation protection and performance requirements, there are other types of policies and the present invention is not limited to the identified types. The artisan will recognize the alternatives. Examples include but are not limited to policies related to zoning, bandwidth, and hops.

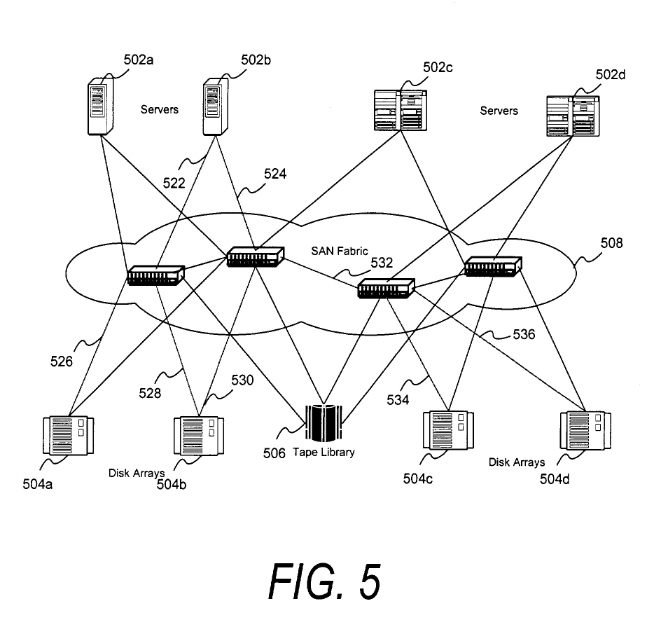

As indicated above, optimization is applied 222 where multiple options are available. Referring to FIG. 5 along with FIG. 2, an example of optimization is described further in connection with the depicted SAN 500 in which various servers 502a-d are connected to various disk arrays 504a-d and a tape library 506 through a SAN fabric 508. Generally, optimization applies the option that maximizes the ability to meet the SLOs given the resource and configuration constraints. As such, optimization is applied 222 with reference to the SLO database 254. The policies identify what must be done, but multiple options might satisfy the requirements of the policies. For example, there may be several solutions that meet the constraint policy and device policies. Optimization evaluates each solution and estimates the “best fit” to meet the service level objectives.

Once the option is identified, it is then applied (220, FIG. 2) to the corresponding devices automatically. Optimization provides the most desirable options for allocation or reconfiguration (changes to) of storage to best meet SLOs. FIG. 5 shows a simple example of how optimization based on performance SLOs can be performed when allocating storage for an application on a server. For example, presume that server 502b requests storage allocation and needs to maximize its application to storage access performance. Optimization could be carried out as follows.

First, as described above, available target candidates that have the required capacity (e.g., 200 GB) and type of storage (RAID 5 or RAID1+0) are found. In this case, presume that each of disk arrays 504a-d match these requirements.

Next, reachable paths from the request source 502b to the target storage devices 504a-d are identified. Here, the paths are referenced as 522-536 as indicated. The reachable path is found by whatever well-known mechanism is supported, depending on the network protocols used in the SAN.

For each identified path, the estimated transit time t from the server to the disk is determined. For every path i, the base transit time tᵢ is estimated. The following equation estimates this base transit time as

$${t}_{i} = L [ \frac{1}{( 1 - {u}_{Hi} ) {B}_{H}} + \frac{1}{( 1 - {u}_{Si} ) {B}_{S}} + \frac{1}{( 1 - {u}_{Di} ) {B}_{D}} ] ,$$

where L is the size of the block written or read from the disk; U_{H} and B_{H} are the utilization and maximum bandwidth for the HBA, u_{S} and B_{S} are the utilization and maximum bandwidth for the switch path, and U_{D} and B_{D} are the utilization and maximum bandwidth for the disk array.

For every disk target, the minimum transit time t is found for each of the available paths (j) according to the equation:

$${t}_{j} = {Min}_{i} \{ {t}_{i} \} = {Min}_{i} \{ [ \frac{1}{( 1 - {u}_{Hi} ) {B}_{H}} + \frac{1}{( 1 - {u}_{Si} ) {B}_{S}} + \frac{1}{( 1 - {u}_{Di} ) {B}_{D}} ] \} .$$

This allows the optimal allocation of storage both as to the allocated storage target and the path from application server to the allocated storage target, and maximizes the ability to adhere to the corresponding performance metric.

Still referring to FIG. 2, if the workflow is determined 224 not to be complete, the loop is continued until all steps of the workflow are executed. As indicated, for each workflow step, the configuration is updated 220 and such updates are reflected in the configuration database, so that subsequent actions account for conditions established by previous actions.

FIG. 3 is a flow diagram illustrating an embodiment of deriving policy rules from service level objectives in accordance with the present invention. As indicated, initially the application and grouping are defined 302. The application may be part of a group of applications, in which case the application inherits 304 the policy rules of the group. All policies and their associated rules are kept in a policy database 352. Derivation of policy rules can also apply to requirements other than the application. For example, any logical group may have a storage policy and applications can be part of a group.

A user interface is provided for defining 306 service level objectives. Service level objectives are defined in terms of cost objectives, capacity planning objectives, performance, availability, data protection, data recovery, and accessibility. There will typically be a tradeoff in service levels as some of these objectives conflict. For example, lowest cost, highest performance, highest availability is unlikely to be available as a valid class of service. The user interface must assist the user in defining an appropriate class of service that is achievable. Also note the storage resources available, classes of arrays, switches and software also have a bearing on the relative capability of meeting a class of service in a particular storage network. Information regarding storage resource capabilities is obtained from the storage resource capability database 358. The storage resource capabilities information is based on known policies for specific vendor/model/device type and local configuration gathered through discovery in the storage network. The service level objectives database 354 is updated to reflect the defined SLOs for the application. The SLOs can be variously organized, and can be completely customized for a particular application if desired. However, in one embodiment the SLOs are based upon discrete class levels, at least in terms of the default set of SLOs to be applied to a particular application. If desired, these can be designated according to familiar classification technology, such as platinum, gold and silver. Examples of SLOs include cost per gigabyte (e.g., can be no more than some amount); time to provision (e.g., can be no more than a given amount of time); time to back up (e.g., can be no longer than a given amount of time); availability (e.g., must be 5 9s, etc.); performance latency (e.g., in x milliseconds).

An example of class levels and corresponding SLOs follows. Although an example is provided, various different class level definitions may of course be provided, and the present invention is not limited to the provided example.

The classes in this example may be referred to as application availability classes, since they define the business significance of different classes of application data and information in the context of need for continuous access. Applications can be grouped into classes that correspond to these default classes, and may adopt them entirely or customize as desired. The classes are generally as follows: Class 1—Not Important to operations, with 90.0% data availability; Class 2—Nice to have available, with 99.% data availability; Class 3—Operationally Important information, with 99.9% data availability; Class 4—Business Vital information, with 99.99% data availability; and Class 5—Mission Critical information, with 99.999% data availability.

An SLO is set for the following measures that correspond to these application availability classes: RTO—Recovery Time Objective, which refers to the amount of time the system's data can be unavailable (downtime); RPO—Recovery Point Objective, which refers to the amount of time between data protection events which translates to the amount of data at risk of being lost; and Data Protection Window, which is the time available in which the data can be copied to a redundant repository without impacting business operations.

Table 1 identifies thresholds for these three service level objectives relative to each class of service.

TABLE 1

| | (RPO) - How Much | | (RTO) - Maximum | | Maximum Window |
|---|---|---|---|---|---|
| Data | Data at Risk | | Recovery Time | | Available |
| Value | (loss) per event | | (downtime % in | | for Data |
| Class | (Minutes) | | days/yr) | | Protection |
| 1 | 10,000 | Min | 7 | days | Days |
| | (1 week) | | (2%) | | |
| 2 | 1440 | min | 1 | day | 24 hrs |
| | (1 day) | | (0.3%) | | |
| 3 | 120 | min | 2 | hrs | 2 hrs |
| | (2 hrs) | | (0.02%) | | |
| 4 | 10 | min | 15 | min | 0.2 hrs |
| | (0.17 hrs) | | (0.003%) | | |
| 5 | 1 | min | 1.5 | min | None |

| | |
|---|---|
| (0.017 hrs) | (0.0003%) |

Policy rules are provided to attain these objectives. An example of policy rules is as follows. The RPO and RTO objectives generally dictate the need for snapshot images, the frequency of same, and the need for mirroring, replication and fail over. Class 1 and 2 would use traditional tape backup on a weekly or daily basis, with no need for mirrored primary storage or snapshot volumes. Class 1 would be Raid 0 and Class 2 would be Raid 5. Class 3 would have snapshots taken every 3 hours and tape backup and recovery with those snapshots up to a predetermined size of file system or database, constrained by the time to recover off near-line media. Class 3 would be Raid 1+0 and snapshots or Raid 5 and snapshots every 2 hours, with the Raid choice being dependent on the performance class of the application. Class 4 would require RAID 1+0 and an asynchronous replicated RAID 1+0 volume in a second Array as a business continuity volume. Snapshot images would also be created on a frequent basis for archiving to tape. The less demanding RTO allows lower cost asynchronous replication to be feasible, up to a latency constraint that meets the RTO objective. Class 5 would require RAID 1+0 and synchronous replication array to array with dynamic fail over and dual paths (e.g., in an EMC Symmetrix or HDS class array with Powerpath or Veritas DMP invoked for multi-path fail over). Other policies can also be provided, by class or as dictated by the application. For example, the performance class of the application could determine the need for a load balancing active-active multi-path solution or a fail over active-passive multi-path solution.

SLOs by application and group are maintained in the SLO database 354. These objectives and metrics are used for monitoring and reporting adherence to SLOs. As indicated, it is determined 308 whether any additions or changes are to be made to the policies based on the SLOs for the application.

Based on the user defined SLOs, a set of constraint policy additions, changes or deletions from the inherited policies is derived 310 to best meet the service level objectives. Again the storage resource capabilities (from database 358) are considered in this derivation. The constraint policies database 356 and in turn the policies database 354 are updated to reflect the derived constraint policies.

The security objectives for the application are then defined 312, preferably through a user interface that is provided to define security objectives beyond the previously defined (306) SLOs. Security policies are stored in a security policy database 360. An example of a security policy is one that limits who may initiate provisioning requests for a given application. Another example is that the provisioning solution for an application may be limited to resources owned by the same security group as the requestor and the application. Although the constraint policies and device policies could be adhered to with a number of different provisioning decisions, the solutions are further filtered by the security policy/rules.

Service Level Metrics and their appropriate threshold or control limits are derived 314 to ensure that proactive correction action can be taken before a SLO breach is reached. The threshold policies are stored in the policy database 352. An example of derived service level metric is a measurement of application storage/data availability, with the threshold being a certain percentage uptime (e.g., 5 9's=99.999% available, or 4 9's=99.99% available). The derived metric to determine this availability is to monitor the critical path storage elements, ports, HBAs, edge ports, switch ports, FA ports, array controller and relevant spindles. The availability percentage is derived by considering the comprehensive availability of each of these critical path points. A user interface is provided to define 316 device policies. Preferred policies are pre-installed in the database reflecting recommendations of the manufacturer. These provide default policies that can be wholly adopted, supplemented, or otherwise manipulated by the user to create a customized set. Some examples of device policies are: 1) Method for mapping volumes to FA ports in an array, lowest peak bandwidth utilization, lowest average bandwidth, round robin; 2) Soft or hard zoning enabled. The threshold policies are also retained in a database 362.

Metrics may be derived as described above. One example of a derived metric is on capacity planning and requires tracking the storage consumed per application on a server on a target disk system. Simple aggregation of the storage consumed across the applications for a specific disk provides utilization of the disk and allows capacity planning. Another metric on performance, such as application response time and I/O rates, is derived form measurements made in the application to end storage system chain. Still another metric on data protection uses scheduling information of storage devices used for data protection can ensure meeting data protection SLOs. The artisan will recognize the various alternatives.

FIG. 6 is a flow diagram illustrating an example of a workflow 600 for allocating a virtual disk and assigning it to a server in accordance with the present invention. Included in the flow diagram are analysis processes that make initial determinations that an allocation can be made according to the scenario prescribed by the policies, and then action processes that carry out the allocation. The action policies may also be constrained by policies, such as the zoning policy as indicated. For each of the process steps, there may be either an applicable policy or user input to affect the execution of the process. Additionally, an audit trail is retained such that as the plurality of workflow steps are performed, input can be received to accommodate returning to a state prior to that for a completed workflow step, or to reject an offered scenario (such as indicated upon completion of the analysis processes as shown, or at any stage during the analysis or action processes). Preferably, each provisioning action results in an entry in an audit trail log for each managed storage element that is modified. Each provisioning log entry has a unique tracking # assigned and a date and time stamp of the request and completion of the action. Relevant information is retained as to the before action state, the requested change and the current status. This information includes configuration settings, such as the Fibre adapter and host port mappings, spindle to volume mappings for LUN creation, zone set and zone membership, and host group membership changes. When executing a workflow scenario the steps of the scenario that result in an action result in an entry. The audit trail based functionality provides the ability to stop the workflow at a particular step and to rollback to an earlier step in the workflow, using the tracking information and relevant information corresponding to each provisioning action. The audit trail steps can be played back in reverse and restored to the before action state in the reverse sequence of the original provisioning process.

The workflow 600 implements the following policies, with corresponding examples in parentheses.

Primary storage allocation policy (ERP storage allocations are 10 gigabytes; exchange storage allocations are 100 gigabytes)

Primary storage vendor policy (ERP storage must be Hitachi; exchange storage can be any type)

Primary storage RAID-type policy (ERP storage must be RAID 5; exchange storage can be any type)

Primary storage performance requirements policy (ERP performance requirements are 2Bbit channel, 50000 IOPS; exchange performance requirements are 1 Gbit channel, 10000 IOPS)

Zoning policy (ERP systems must be placed on ERP zone)

User input is collected 602 in order to establish the policies that will subsequently correspond to the provisioning sequence or other SAN effecting event. Of course, this information can be collected well before an allocation takes place, which can happen automatically once the policies are established. An allocation can correspond to a requestor (application, user, or the like) for new storage. Pursuant to an allocation, the size requirements are initially obtained 604 with reference to the primary storage allocation policy 606. Storage volumes are linked to applications through methods such as the following. In one method, a user interface is provided for identifying the grouping relationship of an application to its server, file system, or data base instance. Another method is that upon discovery the server agent discovers the file system and databases and recognizes common structures such as Exchange or ERP database instance names, file and directory structures and automatically updates the grouping relationship of applications, servers, file systems and database instances. Once an application is identified it can be associated with a set of policies or inherit the policies for applications in the same class as this application, referred to as policy inheritance. One such policy might be at what percentage utilization should expand the file system (a threshold policy) and how much to expand the application if its file system becomes full (a constraint policy/rule). In this example, it is presumed that the allocation is for ERP storage, and therefore the allocation is to expand 20% when you get to 80% full. In this case that results in adding an additional 10 gigabytes. This may be more conservative because the exposure to the business is great if the ERP application fails. A less important application might run with tighter tolerance, expand by 10% when 90% full.

Once the allocation size is obtained as such, the quota policy 610 is referenced in order to determine 608 whether a quota policy violation exists. This is determined by examining whether the additional 10 gigabytes will cause the quota for the requestor to become exceeded. If there is a violation, then an alert is sent 612 to the requestor indicating same. If the quota policy has not yet been violated, then the next policy 616 is referenced in order to determine 614 the appropriate primary storage vendor systems. In this example, since ERP storage is involved, the storage must be Hitachi type according to the policy. Accordingly, the system is checked for the presence of such storage in the requisite amount. There may be more than one qualifying set of storage resources at this or subsequent stages. As with the quota policy, if this policy cannot be adhered to, then an alert 620 is sent to the requestor.

If it is determined 618 to be available, then the process continues by finding 622 the RAID requirement with reference to the Primary storage RAID type policy. Since RAID 5 is required for ERP storage, the previously discovered Hitachi resources are examined to determine 626 whether the RAID 5 configuration can be accommodated. If not, then once again an alert is sent 628 to the requester indicating same.

If the configuration can be accommodated, then performance requirements are checked 630 with reference to the primary storage requirements policy 632. As indicated above, ERP storage requires a 2 Gbit channel and 50,000 IOPS. If it is determined 634 that this performance can be accommodated in connection with the previously identified storage resource targets, then the scenario analysis phase is complete 638 as indicated. If not, then once again an alert and corresponding information are sent 636 to the requester.

User confirmation can be implemented at this stage, if desired. There, the proposed allocation can be conveyed using a conventional interface or other indicia, and conventional mechanisms can be used to gather user responses. If it is determined 640 that the user did not accept the recommendation, then recommendation is not accepted 642 and the process ends.

If applicable, the process continues upon acceptance and the action processes 644-648 carry out the allocation. Particularly, a virtual disk is created 644 (e.g., using conventional SAN management software or the like for creating virtual disks), followed by zoning 646 and then LUN assignment and masking 648, also using conventional disk management processes. If applicable, a zoning policy 650 can constrain the zoning step. Also, parameters supplied in the workflow request 652 can determine the LUN assignment and masking step.

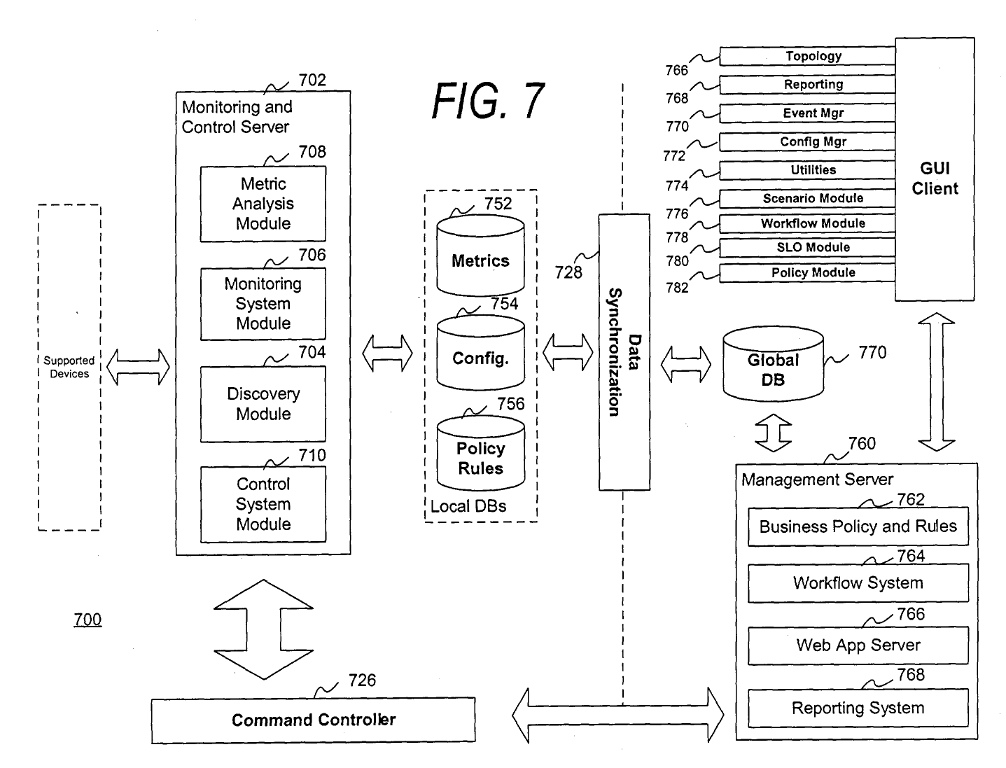

FIG. 7 is a block diagram illustrating an embodiment of a policy based storage resource management system 700. The PBSRM system 700 is preferably embodied as software, but may also incorporate hardware, firmware, and combinations of hardware, firmware and software. The software may be stored in various computer readable media, including but not limited to RAM, ROM, hard disks, tape drives, and the like. The software executes on any conventional or custom platform, including but not limited to a conventional Microsoft Windows based operating system running on a conventional Intel microprocessor based system.

Although the modular breakdown of the PBSRM system 700 can vary, such as providing more or less modules to provide the same overall functionality, an example of a particular modular breakdown is shown and described. The PBSRM 700 also manages and interacts with the various databases that have been previously introduced.

The PBRSM system 700 includes a monitoring and control server 702. The monitoring and control server 702 includes software that is executed to provide the functionality described above in connection with FIG. 2. In this embodiment, the monitoring and control server 702 includes a discovery module 704, monitoring module 706, metric analysis module 708, and a control system module 710. The discovery module 704 detects managed elements that exist in the network, through communications with those elements and access to the configuration database 754. The monitoring module 706 receives information regarding the various device providers, and accesses the configuration database 754 and policy rules database 756. This information allows the monitoring module 706 to collect the necessary metrics information, to monitor information against those metrics, and to make determinations that SLO metrics are out of bounds, such as by determining whether thresholds have been surpassed or other criteria as previously described.

The metric analysis module 708 receives collected metrics, runs calculations against the collected metrics and generates an event if necessary. An alert generation module (not shown) receives indications of events from the metric analysis module 708 detects events and issues alarms corresponding to the various managed elements. The control module 710 generally provides the control system functionality. Particularly, it receives indications where metrics indicate out of bounds operation, and requests for new application or device provisioning. It retrieves workflows and iteratively performs workflow steps by performing necessary control actions, receiving any necessary confirmation, and optimizing provisioning where multiple control action options are presented, as previously described above.

The monitoring and control server 702 also communicates with the management server 760 through a command controller 726. Data synchronization 728 is provided between the same and ensures that the data used by the management server 760 and the local monitoring and control server 702 remain synchronized. This can be accommodated using conventional database management techniques.

The management server 760 includes a business policies and rules module 762, workflow system module 764, web application server 766, and reporting system 768. The management server 760 contains a set of core services, and is preferably J2EE based, providing platform portability and mechanisms for scalability and enterprise messaging. The management server 760 manages a persistent data store 770. This is built on a commercial relational database, preferably HA configuration available. All key data is persisted in the database (configuration, metrics, policies, audit trails, events). Furthermore there are two schemas to the database, one optimized for real time provisioning and event management, the other is a star schema optimized for data mining, trending and reporting analysis.

The business policy and rules module 762 is responsible for performing context-based policy lookup, returning correct policies to tasks in executing workflows, implementing inheritance schemes, and interacting with the GUI for policy creation, modification and deletion.

The workflow system module 764 is responsible for managing the scheduling and execution of scenarios, handling automatic and manual tasks, interacting with users for manual tasks, distributing manual tasks across multiple users, interacting with device and managed element agents and providers for automatic tasks, implementing rollback, with compensating actions on failure, interacting with business and rules policy module 762 during task execution, creating a history/audit trail, fully integrating with security policies, and interacting with the GUI for Workflow and Task Management.

The web application server 766 also provides an interface shown as a GUI client. This is preferably Java Based, provides various functions through which storage management is accommodated. The GUI client functions also variously support the monitoring and control server 802 and management server 860 functions as described above. The functions of the GUI client include those provided by the topology map module 766, reporting module 768, event manager 770, configuration manager 772, utilities module 774, scenario module 776, workflow module 778, SLO module 780, and policy module 782.

The topology map module 766 manages elements and their relationships through topology maps based on queries into a configuration management database. They include physical and logical SAN topology, physical and logical storage configuration, physical and logical network topology, application to server topology, and application to storage topology. The configuration manager 772 allows users to edit, copy, and delete existing objects and relationships in the configuration database. The event manager 770 allows users to view event and alert status and history, and where users can access and change metric analysis and event and alarm subsystem information. The reporting module 768 provides comprehensive reports, such as storage usage history, current storage allocations, and use versus allocated storage. The utilities module 774 provides a set of utilities that allow users to perform certain storage management functions that are device independent including zone manager, LUN manager, virtual disk creator, and virtualization device manager.

The workflow module 778 provides interfaces through which workflow scenarios are presented. The scenario module 776 is a more specialized version of the workflow module 778. It is responsible for the management and execution of scenarios. It handles automatic and manual tasks and corresponds with users as needed. It also accommodates audit trail based rollback in connection with the management server 760 as described. Finally, the SLO module 780 and policy module 782 respectively provide interfaces through which the SLOs and policies are presented and managed.

The control system module 710 implements this interface. In addition to the functionality described above, the control system module 710 provides closed-loop, automatic implementation of device configuration to complete tasks on behalf of the workflow system module 764. The control system module is 710 is part of the monitoring and control server 702. Other elements of this server include a Metric Analysis Module 708, a Monitoring System Module 706, and a Discovery Module 704. The Metrics Analysis Module 708 and the Monitoring Module 706 perform the following: periodically monitoring all known managed system elements; capturing and analyzing metrics, events and configuration changes; providing for user programmable sampling intervals; persisting metrics and configuration changes in the database; managing Providers/Agents responsible for collection of metrics; making delta comparisons propagating changes to the server; sending metrics to threshold processing for further analysis (threshold processing analyzes metrics of interest and compares them to user-specified thresholds); and generating events when thresholds are exceeded. For example, an SLO monitor process looks for events that indicate an SLO criteria failure, which can trigger action by the workflow system 764.

The last element of the Monitoring and Control Server 702 is the Discovery Module 704. The Discovery Module is responsible for finding instances of managed storage elements in the management domain; discovering through IP and in-band over FC (There are multiple discovery methods, a) SNMP b) DNS c) In-Band Fibre (GS3)); enabling a Programmable Discovery Interval; enabling device registration; and connecting the Management Server 760 to the command interface 726 of the managed system elements (storage devices and storage software elements).

Thus embodiments of the present invention produce and provide policy based storage management. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for policy based management of storage resources in a storage network, the method comprising:
receiving a set of service level objectives corresponding to a storage resource requestor;
determining a set of policy rules corresponding to the set of service level objectives; and
updating a configuration of the storage network corresponding to the storage resource requestor and a target storage resource according to the set of policy rules, whereby the service level objectives of the storage resource requestor are satisfied as the storage resource requestor uses the target storage resource.

2. The method of claim 1, wherein the set of policy rules includes a threshold policy, and a metric corresponding to the threshold policy is derived to accommodate monitoring use of the target storage resource by the storage resource requestor.

3. The method of claim 2, further comprising:
detecting an out of bounds condition by monitoring use of the target storage resource by the storage resource requestor against the metric; and
automatically reconfiguring the storage network where the out of bounds condition is detected.

4. The method of claim 1, wherein updating a configuration of the storage network corresponding to the storage resource requestor and a target storage resource according to the set of policy rules further comprises:
determining that multiple potential storage resource configurations will satisfy the service level objectives of the storage resource requester using the set of policy rules, wherein a configuration involving the target storage resource is among the multiple potential storage resource configurations; and
selecting the configuration involving the target storage resource based upon an optimization algorithm that prompts selection based upon a maximized likelihood that the service level objectives of at least the storage resource requestor will be met by the selected configuration.

5. The method of claim 1, wherein the storage resource requestor is an application.

6. The method of claim 5, wherein the set of service level objectives corresponding to the application are determined from a class of service having predetermined service level objectives.

7. The method of claim 6, wherein additional service level objectives supplement the predetermined service level objectives for the application.

8. The method of claim 5, further comprising:
receiving a second set of service level objectives corresponding to a second application;
determining a second set of policy rules corresponding to the second set of service level objectives; and
updating a configuration of the storage network corresponding to the second application and a second target storage resource according to the second set of policy rules, whereby differing service level objectives for the first application and the second application are satisfied.

9. The method of claim 1, wherein updating the configuration of the storage network further comprises:
determining that the update pertains to a provisioning of storage resources; and
invoking a workflow including a plurality of workflow steps for the provisioning of storage resources, wherein the workflow implements the set of policy rules.

10. The method of claim 9, wherein the plurality of workflow steps include analysis steps that make initial determinations regarding a storage allocation according to a scenario prescribed by the set of policy rules, and action steps that carry out the storage allocation.

11. The method of claim 10, wherein a confirmation is received prior to performing the action steps.

12. The method of claim 9, wherein an audit trail is retained as the plurality of workflow steps are performed, and an input is received to accommodate returning to a state prior to that for a completed workflow step using the audit trail.

13. A computer program product for policy based management of storage resources in a storage network, the computer program product stored on a computer readable medium and adapted to perform operations comprising:
receiving a set of service level objectives corresponding to a storage resource requester;
determining a set of policy rules corresponding to the set of service level objectives; and
updating a configuration of the storage network corresponding to the storage resource requestor and a target storage resource according to the set of policy rules, whereby the service level objectives of the storage resource requestor are satisfied as the storage resource requestor uses the target storage resource.

14. The computer program product of claim 13, wherein the set of policy rules includes a threshold policy, and a metric corresponding to the threshold policy is derived to accommodate monitoring use of the target storage resource by the storage resource requestor.

15. The computer program product of claim 14, wherein the instructions further comprise:
detecting an out of bounds condition by monitoring use of the target storage resource by the storage resource requestor against the metric; and
automatically reconfiguring the storage network where the out of bounds condition is detected.

16. The computer program product of claim 13, wherein updating a configuration of the storage network corresponding to the storage resource requestor and a target storage resource according to the set of policy rules further comprises:
determining that multiple potential storage resource configurations will satisfy the service level objectives of the storage resource requester using the set of policy rules, wherein a configuration involving the target storage resource is among the multiple potential storage resource configurations; and
selecting the configuration involving the target storage resource based upon an optimization algorithm that prompts selection based upon a maximized likelihood that the service level objectives of at least the storage resource requestor will be met by the selected configuration.

17. The computer program product of claim 13, wherein the storage resource requester is an application.

18. The computer program product of claim 17, wherein the set of service level objectives corresponding to the application are determined from a class of service having predetermined service level objectives.

19. The computer program product of claim 18, wherein additional service level objectives supplement the predetermined service level objectives for the application.

20. The computer program product of claim 17, further comprising:
receiving a second set of service level objectives corresponding to a second application;
determining a second set of policy rules corresponding to the second set of service level objectives; and
updating a configuration of the storage network corresponding to the second application and a second target storage resource according to the second set of policy rules, whereby differing service level objectives for the first application and the second application are satisfied.

21. The computer program product of claim 13, wherein updating the configuration of the storage network further comprises:
determining that the update pertains to a provisioning of storage resources; and
invoking a workflow including a plurality of workflow steps for the provisioning of storage resources, wherein the workflow implements the set of policy rules.

22. The computer program product of claim 21, wherein the plurality of workflow steps include analysis steps that make initial determinations regarding a storage allocation according to a scenario prescribed by the set of policy rules, and action steps that carry out the storage allocation.

23. The computer program product of claim 22, wherein a confirmation is received prior to performing the action steps.

24. The computer program product of claim 21, wherein an audit trail is retained as the plurality of workflow steps are performed, and an input is received to accommodate returning to a state prior to that for a completed workflow step using the audit trail.

25. An apparatus for policy based management of storage resources in a storage network, the apparatus comprising:
means for receiving a set of service level objectives corresponding to a storage resource requestor;
means for determining a set of policy rules corresponding to the set of service level objectives; and
means for updating a configuration of the storage network corresponding to the storage resource requestor and a target storage resource according to the set of policy rules, whereby the service level objectives of the storage resource requestor are satisfied as the storage resource requestor uses the target storage resource.

26. The apparatus of claim 25, wherein the set of policy rules includes a threshold policy, and a metric corresponding to the threshold policy is derived to accommodate monitoring use of the target storage resource by the storage resource requester.

27. The apparatus of claim 26, further comprising:
means for detecting an out of bounds condition by monitoring use of the target storage resource by the storage resource requestor against the metric; and
means for automatically reconfiguring the storage network where the out of bounds condition is detected.

28. The apparatus of claim 25, wherein the means for updating a configuration of the storage network corresponding to the storage resource requestor and a target storage resource according to the set of policy rules further comprises:
means for determining that multiple potential storage resource configurations will satisfy the service level objectives of the storage resource requestor using the set of policy rules, wherein a configuration involving the target storage resource is among the multiple potential storage resource configurations; and
means for selecting the configuration involving the target storage resource based upon an optimization algorithm that prompts selection based upon a maximized likelihood that the service level objectives of at least the storage resource requester will be met by the selected configuration.

29. The apparatus of claim 25, wherein the storage resource requestor is an application.

30. The apparatus of claim 29, wherein the set of service level objectives corresponding to the application are determined from a class of service having predetermined service level objectives.

31. The apparatus of claim 30, wherein additional service level objectives supplement the predetermined service level objectives for the application.

32. The apparatus of claim 25, wherein the means for updating the configuration of the storage network further comprises:
means for determining that the update pertains to a provisioning of storage resources; and
means for invoking a workflow including a plurality of workflow steps for the provisioning of storage resources, wherein the workflow implements the set of policy rules.

33. The apparatus of claim 32, wherein the plurality of workflow steps include analysis steps that make initial determinations regarding a storage allocation according to a scenario prescribed by the set of policy rules, and action steps that carry out the storage allocation.

34. The apparatus of claim 33, wherein a confirmation is received prior to performing the action steps.

35. The apparatus of claim 32, wherein an audit trail is retained as the plurality of workflow steps are performed, and an input is received to accommodate returning to a state prior to that for a completed workflow step using the audit trail.

36. A system for policy based management of storage resources in a storage network, the system comprising:
a monitoring module, which receives a set of service level objectives corresponding to a storage resource requestor and determines a set of policy rules corresponding to the set of service level objectives; and
a control module, in communication with the monitoring system module, which updates a configuration of the storage network corresponding to the storage resource requester and a target storage resource according to the set of policy rules, whereby the service level objectives of the storage resource requester are satisfied as the storage resource requester uses the target storage resource.

37. The system of claim 36, wherein the set of policy rules includes a threshold policy, and a metric corresponding to the threshold policy is derived to accommodate monitoring use of the target storage resource by the storage resource requester.

38. The system of claim 37, further comprising:
a metric analysis module, in communication with the monitoring module and the control module, which accommodates detection of an out of bounds condition by monitoring use of the target storage resource by the storage resource requestor against the metric, and communicates with the control module to automatically reconfigure the storage network where the out of bounds condition is detected.

39. The system of claim 36, wherein the control module updates the configuration of the storage network corresponding to the storage resource requester and a target storage resource according to the set of policy rules by determining that multiple potential storage resource configurations will satisfy the service level objectives of the storage resource requester using the set of policy rules, wherein a configuration involving the target storage resource is among the multiple potential storage resource configurations, and selecting the configuration involving the target storage resource based upon an optimization algorithm that prompts selection based upon a maximized likelihood that the service level objectives of at least the storage resource requestor will be met by the selected configuration.

40. The system of claim 36, wherein the storage resource requester is an application.

41. The system of claim 40, wherein the set of service level objectives corresponding to the application are determined from a class of service having predetermined service level objectives.

42. The system of claim 41, wherein additional service level objectives supplement the predetermined service level objectives for the application.

43. The system of claim 40, wherein the monitoring module receives a second set of service level objectives corresponding to a second application and determines a second set of policy rules corresponding to the second set of service level objectives, and the control module updates a configuration of the storage network corresponding to the second application and a second target storage resource according to the second set of policy rules, whereby differing service level objectives for the first application and the second application are satisfied.

44. The system of claim 36, wherein the control module updates the configuration of the storage network by determining that the update pertains to a provisioning of storage resources, and invoking a workflow including a plurality of workflow steps for the provisioning of storage resources, wherein the workflow implements the set of policy rules.

45. The system of claim 44, wherein the plurality of workflow steps include analysis steps that make initial determinations regarding a storage allocation according to a scenario prescribed by the set of policy rules, and action steps that carry out the storage allocation.

46. The system of claim 35, wherein a confirmation is received prior to performing the action steps.

47. The system of claim 44, wherein an audit trail is retained as the plurality of workflow steps are performed, and an input is received to accommodate returning to a state prior to that for a completed workflow step using the audit trail.
